(19) United States
(12) Patent Application Publication
(10) Pub. No.: US 2002/0127969 A1
(43) Pub. Date: Sep. 12, 2002

(54) Wireless network storage device and method

(76) Inventor: William Kendall Meade II, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/804,007

(22) Filed: Mar. 12, 2001

(51) Int. Cl. H04B 5/00

(52) U.S. Cl. 455/41; 455/420; 455/517

(57) ABSTRACT

Wireless content storage and transfer systems and methods are provided in accordance with the present invention. The system comprises a storage device configured to receive content from a service provider and store the content. The storage device further comprises at least one transmitter configured to wirelessly transmit the content to any wireless communication device within a range of the transmitter.

### BACKGROUND OF THE INVENTION

1. Field of the Invention

The present invention relates to communication systems, and more particularly to a wireless content storage and transfer system and method.

2. Description of the Related Art

Personal digital assistants (PDAs) and other wireless communication devices have limited bandwidth, speed and memory capacity for receiving and storing content, such as Internet content.

### SUMMARY OF THE INVENTION

Wireless content storage and transfer systems and methods are provided in accordance with the present invention. One system in accordance with the present invention uses a storage device with a disk array and at least one transmitter. The transmitter transmits content to any compatible wireless communication device within a range of the transmitter. One advantage of the system is using the time spent by consumers waiting in traffic, at a car repair shop, a doctor's office or a store check-out line to provide Internet or Ethernet content to consumers.

One aspect of the invention relates to a communication system comprising a storage device and a transmitter. The storage device is configured to receive content from a service provider and store the content. The transmitter is coupled to the storage device and is configured to transmit the content stored in the storage device to at least one compatible communication device.

Another aspect of the invention relates to a method of storing and transferring content. The method comprises receiving content from a service provider; storing the content in a storage device; and transmitting the content with a transmitter to at least one compatible communication device within a range of the transmitter.

### BRIEF DESCRIPTION OF THE DRAWINGS

FIG. 1 illustrates one embodiment of a wireless content storage and transfer system.

FIG. 2 illustrates one embodiment of a method of storing and transferring content.

### DETAILED DESCRIPTION

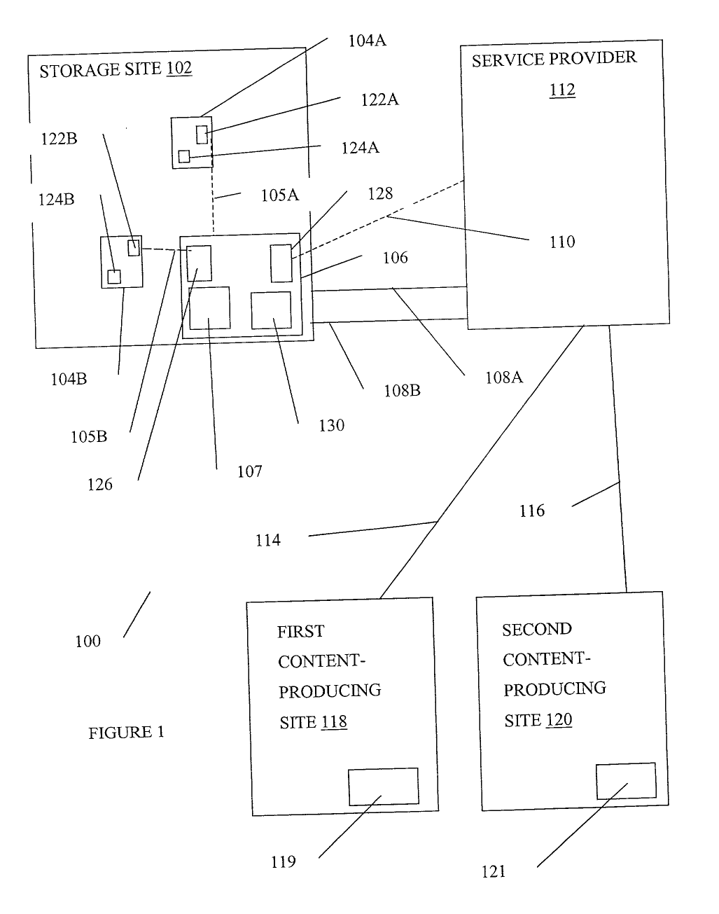

FIG. 1 illustrates one embodiment of a wireless content storage and transfer system 100. The system 100 comprises a storage site 102, one or more wireless communication devices 104A, 104B (referred to herein individually or collectively as 104), a network device 106, at least one wired communication path 108A, a content or service provider 112, a first content-producing site 118, a second communication device 119, a second content-producing site 120 and a third communication device 121. The system 100 may comprise any number of storage sites with network devices, such as the storage site 102 network device 106 in FIG. 1, and content-producing sites, such as the second content-producing site 118.

The storage site 102 may be a commercial building or location, such as a car repair shop, an airport, a train station, an office building, a doctor's office, a grocery store, a shopping mall, a traffic stop or a highway rest stop. Alternatively, the storage site 102 may be a residential building or location, such as a house, an apartment complex or a hotel. The storage site 102 may have a rack enclosure, such as a 3U K rack enclosure made by Hewlett Packard of Palo Alto, Calif., for the network device 106.

The wireless communication devices 104A, 104B may be any portable communication device, such as for example, a PDA, a lap top computer, a wireless phone or a pager. Exemplifying PDAs include products made by Palm, Visor, Casio, Microsoft or PalmSpring. Each wireless device 104 comprises a receiver 122 (receivers 122A and 122B are referred to herein individually or collectively as receiver 122) that is configured to receive wireless signals from the network device 106. Each wireless device 104 may further comprise a transmitter (integrated with the receiver 122 or a separate transmitter), a display, a keypad, a memory, a microprocessor and an input/output port. Each wireless communication device 104 may further comprise a button or key 124 to activate (enable) or deactivate (disable) communication with the network device 106.

The network device 106 may also be referred to as a base station or a proxy server. The network device 106 comprises a transmitter 126, an optional firewall device 130 and a storage device 107, such as a disk drive, an array of disk drives or a solid state memory. The network device 106 may further comprise a receiver 128 configured to receive wireless signals from the service provider 112. The network device 106 is preferably a high-capacity storage device. For example, the storage device 107 may comprise an HP Surestore Disk Array XP512, an HP Surestore Disk Array XP48, an HP Surestore Disk Array FC60, an HP Surestore Disk Array 12H, a Disk System 2100, a Disk System HVDIO, a Disk System SC10 or an HP Surestore 18GB Hard Disk Drive manufactured by Hewlett Packard. The network device 106 may comprise a Redundant Array of Independent Disks (RAID). Other types of storage devices, such as solid state storage devices, may be used in accordance with the present invention. The storage device 107 is configured to store content, such as emails, sale information, advertising, stock quotes or news reports.

The wired communication path 108A between the storage site 102 and the service provider 112 may be, for example, a line, a twisted wire pair of telephone line, a cable or a fiber optic cable. In one embodiment, a first wired communication path 108A provides a publicly-accessible communication line, while a second communication path 108B may provide a secured line for the storage site 102 to exchange private information with the service provider 112. These two paths 108A, 108B may be referred to as a virtual private network, which allows secure transmission on insecure networks. Instead of or in addition to the wired communication path 108A, the storage site 102 may also communicate with the service provider 112 via a wireless communication channel 110.

The optional firewall device 130 is configured to filter data or control signals. The optional firewall device 130 may (1) prevent the network device 106 from receiving particular data or commands from the wireless communication devices 104A, 104B or (2) prevent the network device 106 from transmitting particular data or commands from the wireless communication devices 104A, 104B to the service provider 112. The optional firewall device 130 provides security for the storage site 102 for its own network access by preventing unknown users from gaining access to sensitive network data.

The service provider 112 may be a telephone company, a network provider, an Internet server or an Ethernet server. The first content-producing site 118 and second content-producing site 120 may be commercial or residential buildings or locations. The second communication device 119 and the third communication device 121 may be personal computers, servers, video cameras or other content input/output device.

The network device 106 communicates with any compatible wireless communication device 104 via signals on a wireless communication channel 105. For example, the signals may be as radio-frequency signals or infrared signals. Short-range or long-range signals may be used. The signals may conform to a communication standard, such as an IEEE standard for wireless local area networks (LANs), e.g., 802.11, Bluetooth or Wireless Application Protocol (WAP). The network device 106 may have a plurality of transmitters to communicate with a plurality of different communication devices 104A, 104B using different methods of communication. For example, the network device 106 may have a radio frequency transmitter to transmit signals to the first communication device 104A and an infrared transmitter to transmit signals to the second communication device 104B.

In addition to or instead of the transmitter 126, the network device 106 may comprise an output port that is configured to transmit content to one or more communication devices 104 when the output port is physically coupled to a communication device 104. The output port may be part of a docking station that is configured to receive one or more communication devices 104.

In operation, the communication devices 119, 121 of the first and second content-producing sites 118, 120 may send content, such as emails, news reports or images, to the service provider 112. The service provider 112 transmits the content from the first and second content-producing sites 118, 120 to the network device 106 via path 108A and/or channel 110. The service provider 112 may also transmit content generated by the service provider 112 itself to the network device 106.

There are several possible methods of content transmission. In one embodiment, the service provider 112 transmits content continuously to the network device 106. In another embodiment, the service provider 112 queues the content and transmits the content to the network device 106 when the queue reaches a pre-determined storage level. In another embodiment, the service provider 112 stores the content and periodically transfers the content to the network device 106.

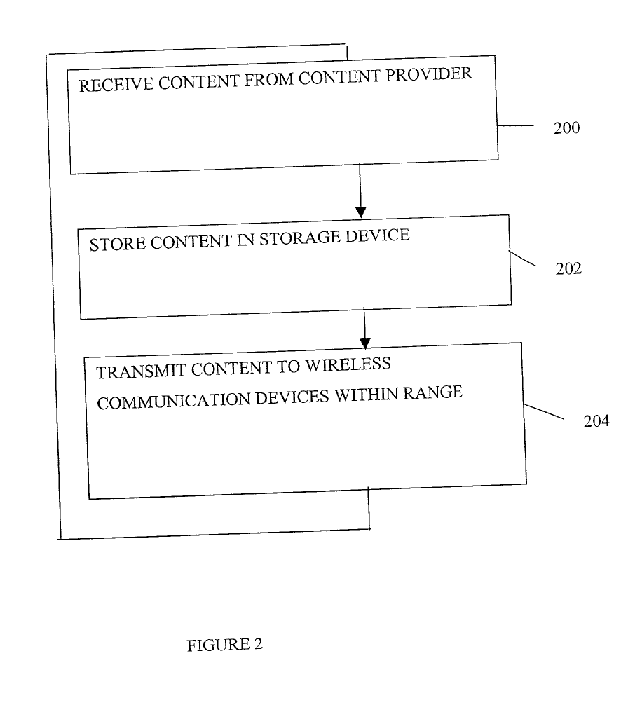

FIG. 2 illustrates one embodiment of a method of storing and transferring content. In a block 200, the network device 106 receives content from the service provider 112. In a block 202, the network device 106 stores content from the service provider 112 in the storage device 107. In a block 204, the network device 106 transfers the content to each wireless communication device 104 that is activated and within a particular range. The range may be a reception range or a transmission range.

The network device 106 may provide a variety of Internet or Ethernet content to a local portable communication device 104. The Internet or Ethernet content may comprise, for example, emails, images, videos, audio samples, Internet Relay Chat (IRC), sale information, consumer reports, stock quotes or news reports on current events, sports or weather. For example, the network device 106 may forward news reports to users with communication devices 104 who subscribe to a news-providing service. In addition, the network device 106 may insert content, such as advertising, that is related to the storage site 102.

Each communication device 104 may display the content from the network device 106 on a display or store the content in a memory in the communication device 104. Each communication device 104 may also send content requests to the network device 106. If the network device 106 does not have the requested content, the network device 106 may forward the request to the service provider 112. Each communication device 104 may also send emails or reports to the network device 106 for transmission to the service provider 112.

The above-described embodiments of the present invention are merely meant to be illustrative and not limiting. Various changes and modifications may be made without departing from the invention in its broader aspects. The appended claims encompass such changes and modifications within the spirit and scope of the invention.

What is claimed is:

1. A communication system comprising:
a storage device configured to receive content from a service provider and store the content; and
a transmitter coupled to the storage device, the transmitter being configured to transmit the content stored in the storage device to at least one compatible communication device.

2. The communication system of claim 1, wherein the service provider is configured to receive content from at least one content producer.

3. The communication system of claim 1, wherein the storage device is a solid state memory.

4. A storage device configured to receive content from a service provider and store the content, the storage device comprising:
a disk drive unit configured to store the content; and
at least one transmitter coupled to the disk drive unit, the at least one transmitter being configured to transmit the content stored in the disk drive unit to at least one compatible communication device within a range of the transmitter.

5. The storage device of claim 4, wherein at least one transmitter uses infrared signals to transmit the content.

6. The storage device of claim 4, wherein at least one transmitter transmits signals according to Bluetooth specifications.

7. The storage device of claim 4, wherein at least one transmitter uses radio-frequency signals to transmit the content.

8. The storage device of claim 4, wherein a first transmitter uses radio-frequency signals to transmit the content, and a second transmitter uses infrared signals to transmit the content.

9. The storage device of claim 4, wherein the content comprises video signals.

10. The storage device of claim 4, wherein the content comprises audio signals.

11. The storage device of claim 4, wherein the content comprises data files.

12. The storage device of claim 4, wherein the content comprises Internet content.

13. The storage device of claim 4, further comprising an output port configured to transmit content to at least one communication device when the output port is physically coupled to the communication device.

14. The storage device of claim 4, wherein the transmitter is configurable to wirelessly transmit content to at least one compatible wireless communication device within a range of the transmitter and not transmit content to at least one compatible wireless communication device within a range of the transmitter.

15. The storage device of claim 4, wherein the disk drive unit comprises an array of disk drives.

16. A method of storing and transferring content, the method comprising:
receiving content from a service provider;
storing the content in a storage device; and
transmitting the content with a transmitter to at least one compatible communication device within a range of the transmitter.

17. The method of claim 16, wherein the content comprises Internet content.

18. The method of claim 16, wherein transmitting content comprises transmitting infrared signals.

19. The method of claim 16, wherein transmitting content comprises transmitting signals according to Bluetooth specifications.

20. The method of claim 16, wherein transmitting content comprises transmitting radio-frequency signals.

21. The method of claim 16, further comprising:
receiving a request for content from a communication device;
transmitting the request to a service provider; and
transmitting the requested content with the transmitter to the communication device that requested the content.
